(19) United States
(12) Patent Application Publication
(10) Pub. No.: US 2015/0079571 A1
(43) Pub. Date: Mar. 19, 2015

(54) Chemistry Instructional Material

(71) Applicant: Julia English WINTER, Bloomfield Hills, MI (US)

(72) Inventor: Julia English WINTER, Bloomfield Hills, MI (US)

(21) Appl. No.: 14/488,964

(22) Filed: Sep. 17, 2014

Related U.S. Application Data
(60) Provisional application No. 61/960,419, filed on Sep. 18, 2013.

(51) Int. Cl. G09B 7/02; G09B 23/26

(52) U.S. Cl. CPC G09B 7/02; G09B 23/26
USPC 434/278

(57) ABSTRACT

An electronic device includes a display and a computer processor. The computer processor is configured to present to a user a first drawing of a cyclohexane ring in a first chair conformation and a second drawing of a cyclohexane ring in a second chair conformation. The first drawing of a cyclohexane ring displays a first bond in either an axial or equatorial position. The second chair conformation is different than the first chair conformation. The computer processor is further configured to receive a first input from the user for a carbon position of the first bond and an angular orientation of the first bond. The computer processor is also configured to indicate to the user whether the first input was correct or incorrect.

### CROSS-REFERENCE TO RELATED APPLICATION

This application claims the benefit of U.S. provisional application Ser. No. 61/960,419 filed Sep. 18, 2013, the disclosure of which is hereby incorporated in its entirety by reference herein.

### TECHNICAL FIELD

The present invention is related to computer processor applications for teaching chemical stereochemistry, and in particular, to applications for teaching bond relationships in cyclohexane rings.

### BACKGROUND

The widespread use of computers and smart devices has significantly changed the manner in which people play, learn and study. Video games are perhaps the earliest form of electronic device-based application that has attained general acceptance. More recently, electronic books are becoming more and more common and are expected to surpass paper books in the near future. Similarly, online education has become an accepted alternative to classroom study.

For the most part, video games though widespread provide little educational benefit. The typical video game provides significant visual stimulation and perception of action. Educational video games do exist, but tend to be directed more to the elementary school level. Advanced electronic games such as electronic crossword puzzles are typically just direct conversions of the paper game to electronic form. Few electronic games target an older audience to teach advanced scientific and engineering topics.

Accordingly, there is a need for advanced computer games that are enjoyable for users while teaching difficult scientific and engineering concepts.

### SUMMARY

The present invention solves one or more problems of the prior art by providing, in at least one embodiment, an electronic device for playing a game. The electronic device includes a display and a computer processor. The computer processor is configured to present to a user a first drawing of a cyclohexane ring in a first chair conformation and a second drawing of a cyclohexane ring in a second chair conformation. The first drawing of a cyclohexane ring displays a first bond in either an axial or equatorial position. The second chair conformation is different than the first chair conformation. The computer processor is further configured to receive a first input from the user for a carbon position of the first bond and an angular orientation of the first bond. The computer processor is also configured to indicate to the user whether the first input was correct or incorrect.

In another embodiment, a non-transitory computer-readable medium that includes instructions for a stereochemistry game application is provided. The instructions, when executed by a computer processor, perform operations that present a user with a first drawing of a cyclohexane ring in a first chair conformation, and that present to the user a second drawing of a cyclohexane ring in a second chair conformation. The first drawing of a cyclohexane ring displays a first bond in either an axial or equatorial position. The second chair conformation is characteristically different than the first chair conformation. The instructions when executed also perform operations that receive a first input from the user for a carbon position of the first bond and an angular orientation of the first bond and then indicate to the user that the first input was correct or incorrect.

### BRIEF DESCRIPTION OF THE DRAWINGS

FIG. 1 is a schematic illustration of an electronic device implementing a cyclohexane stereochemistry game;

FIG. 2 is a schematic flowchart showing the operation of a cyclohexane stereochemistry game in which the position of a single axial or equatorial bond is to be identified by a user;

FIG. 3 is a schematic flowchart showing the operation of a cyclohexane stereochemistry game in which the position of two axial or equatorial bonds are to be identified by a user;

FIG. 4 is a schematic flowchart showing the operation of a cyclohexane stereochemistry game in which the positions of three axial or equatorial bonds are identified by a user; and

FIG. 5 is a schematic flowchart illustrating an example of a chiral center game.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein some features may be exaggerated or minimized to show details of particular components. Therefore, specific structural and functional details disclosed herein are not to be interpreted as limiting, but merely as a representative basis for teaching one skilled in the art to variously employ the present invention.

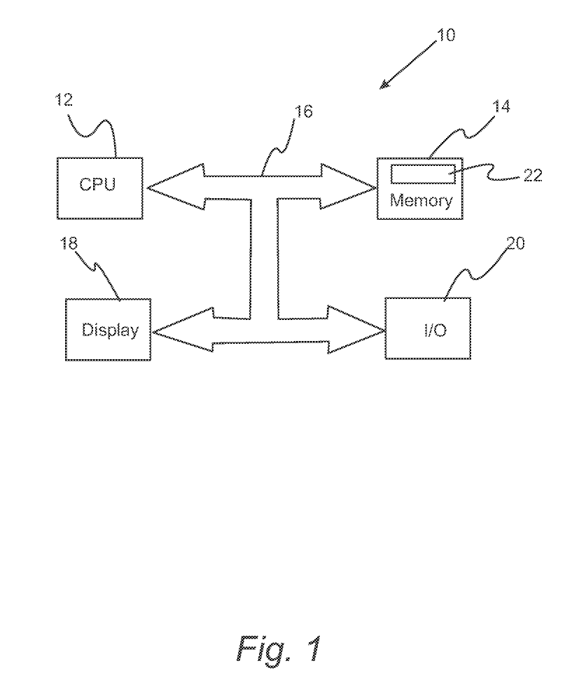

With reference to FIG. 1, a schematic illustration of an electronic device implementing a stereochemistry game is provided. The stereochemistry game is either a cyclohexane stereochemistry game or a chiral center game each independently set forth below in more detail Electronic device 10 includes computer processor 12 that executes the instructions for the game. It should be appreciated that virtually any type of computer processor may be used, including microprocessors, multicore processors, and the like. The instructions for the game typically are stored in computer memory 14 and accessed by computer processor 10 via connection system 16. In a variation, connection system 16 includes a data bus. In a refinement, computer memory 14 includes a computer-readable medium which can be any non-transitory (e. g., tangible) medium that participates in providing data that may be read by a computer. Specific examples for computer memory 14 include, but are not limited to, random access memory (RAM), read only memory (ROM), hard drives, optical drives, removable media (e.g. compact disks (CDs), DVD, flash drives, memory cards, etc.), and the like, and combinations thereof In another refinement, computer processor 12 receives instructions from computer memory 14 and executes these instructions, thereby performing one or more processes, including one or more of the processes described herein. Computer-executable instructions may be compiled or interpreted from computer programs created using a variety of programming languages and/or technologies including, without limitation, and either alone or in combination, Java, C, C++, C#, Fortran, Pascal, Visual Basic, Java Script, Perl, PL/SQL, etc. Display 18 is also in communication with computer processor 12 via connection system 16. Electronic device 10 also optionally includes various in/out ports 20 through which data from a pointing device may be accessed by computer processor 12. Examples for the electronic devices include, but are not limited to, desktop computers, smart phones, tablets, or tablet computers.

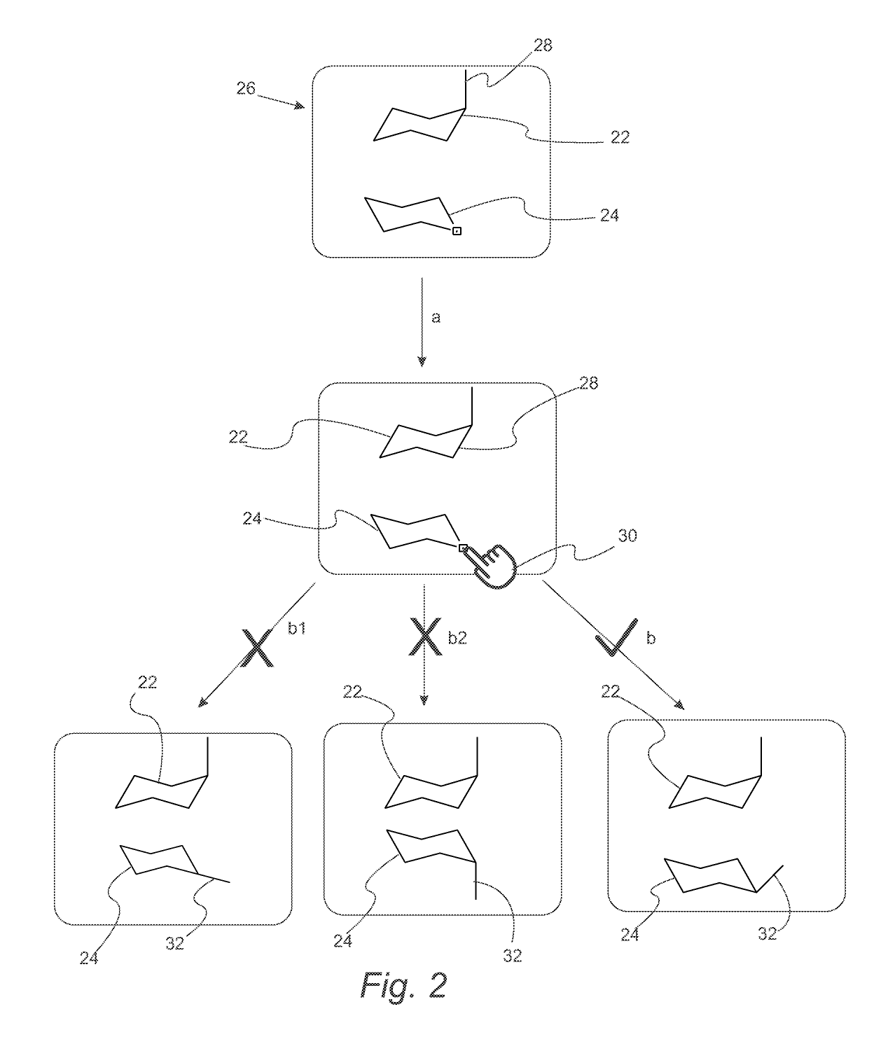

With reference to FIGS. 1 and 2, operation of electronic device 10 for the cyclohexane stereochemistry is described. FIG. 2 is a schematic flowchart showing a cyclohexane stereochemistry game in which the position of a single axial or equatorial bond is to be identified. The computer processor 12 is configured to present to a user (i.e., a player) in step a) a first drawing 22 of a cyclohexane ring in a first chair conformation and a second drawing 24 of a cyclohexane ring in a second chair conformation as depicted in screen image 26. The first drawing 22 of a cyclohexane ring displays a first bond 28 in either an axial or equatorial position. The second chair conformation is different than the first chair conformation. The computer processor 12 is further configured to receive in step b) a first input 30 from the user 32 for a carbon position of the first bond and an angular orientation of the first bond. The computer processor is also configured to indicate to the user whether the first input was correct or incorrect. FIG. 2 indicates that the selections in steps b1) and b2 were incorrect and the selection in step b) is correct.

In a variation, the display 18 is a touch screen display by which the user creates the first input using touch screen operations to draw the first input. Specifically, the user touches the carbon atom to which the first bond is to be drawn and then draws the bond with an angular orientation. Similarly, the user can use a pointing device to create the first input in the same manner. Examples of such pointing devices include, but are not limited to, the computer mouse, trackballs, touch pads, and the like. In either scenario, the computer processor is further configured to identify the angular orientation as axial or equatorial that is approximated by the direction drawn by the user. If the user's first input is incorrect, the processor is further configured to receive a subsequent input from the user as indicated by loop c).

In some variations, the first drawing will include multiple bonds for which the user must provide inputs regarding the position and angular orientations. Specifically, the first drawing of a cyclohexane ring displays at least one additional bond in either an axial or equatorial position. For example, the first cyclohexane ring might include 2, 3, 4, 5 or 6 bonds for the user to provide input on the second drawing of a different conformation. Therefore, in this variation, the processor is further configured to receive an additional input from the user for a carbon position of the additional bond and an angular orientation of the additional bond.

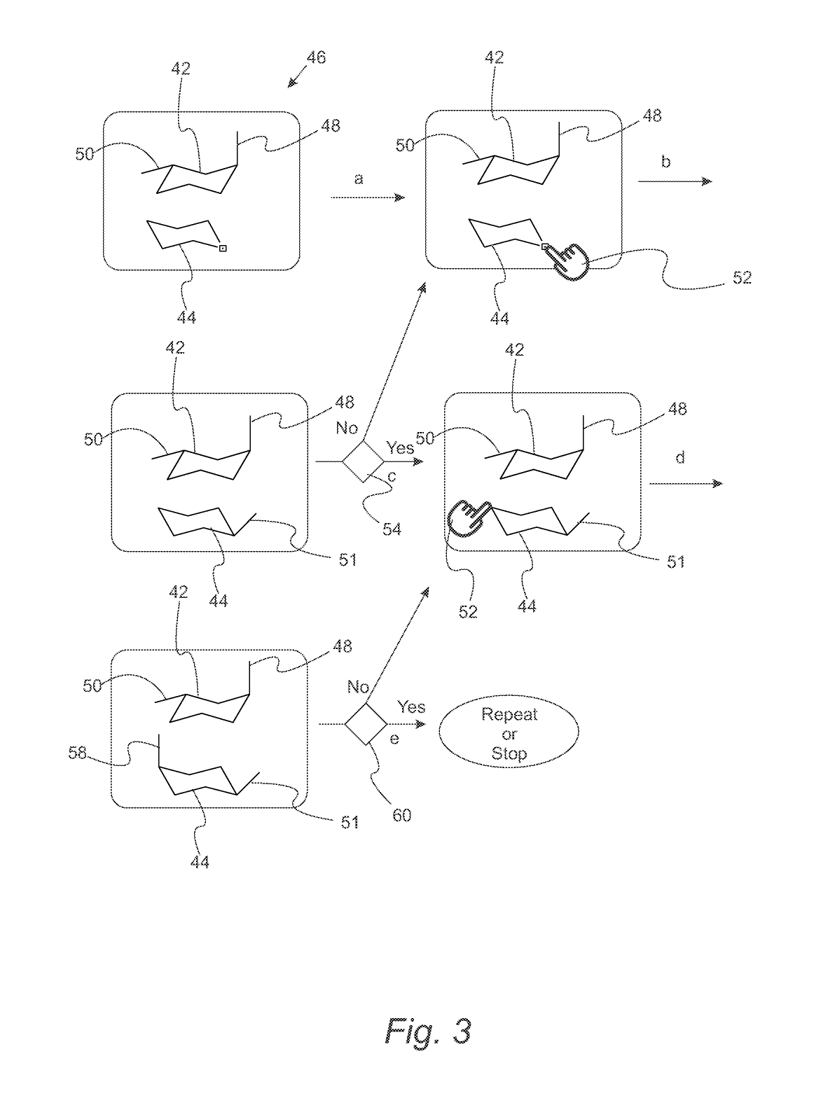

With reference to FIGS. 1 and 3, a variation of the cyclohexane stereochemistry game in which the positions of two axial or equatorial bonds are to be identified is provided. FIG. 3 is a schematic flowchart showing a game in which the positions of two axial or equatorial bonds are to be identified. In step a), a first drawing 42 of a cyclohexane ring in a first chair conformation and a second drawing 44 of a cyclohexane ring in a second chair conformation is depicted in screen image 46. The first drawing 42 of a cyclohexane ring displays bonds 48 and 50 each independently in either an axial or equatorial position. Characteristically, the second chair conformation is different than the first chair conformation. The computer processor 12 is further configured to receive in step b) a first input 51 from the user 52 for a carbon position of the first bond and an angular orientation of the bond 48. The computer processor is also configured to indicate to the user whether the first input was correct or incorrect as indicated by decision point 54 of step c). In a variation, if user 52 has not drawn bond 48 correctly, computer processor 12 is further configured to loop back and provide the user with another chance. If the user has correctly drawn bond 48, the computer processor is further configured to execute step d) in which a second input 58 is received. The computer processor is also configured to indicate to the user whether the first input was correct or incorrect as indicated by decision point 60 of step e). In a variation, if user 52 has not drawn bond 50 correctly, computer processor 12 is further configured to loop back and provide the user with another chance. If the user has correctly drawn bond 48, the computer processor is further configured to either end the game or provide another cyclohexane drawing.

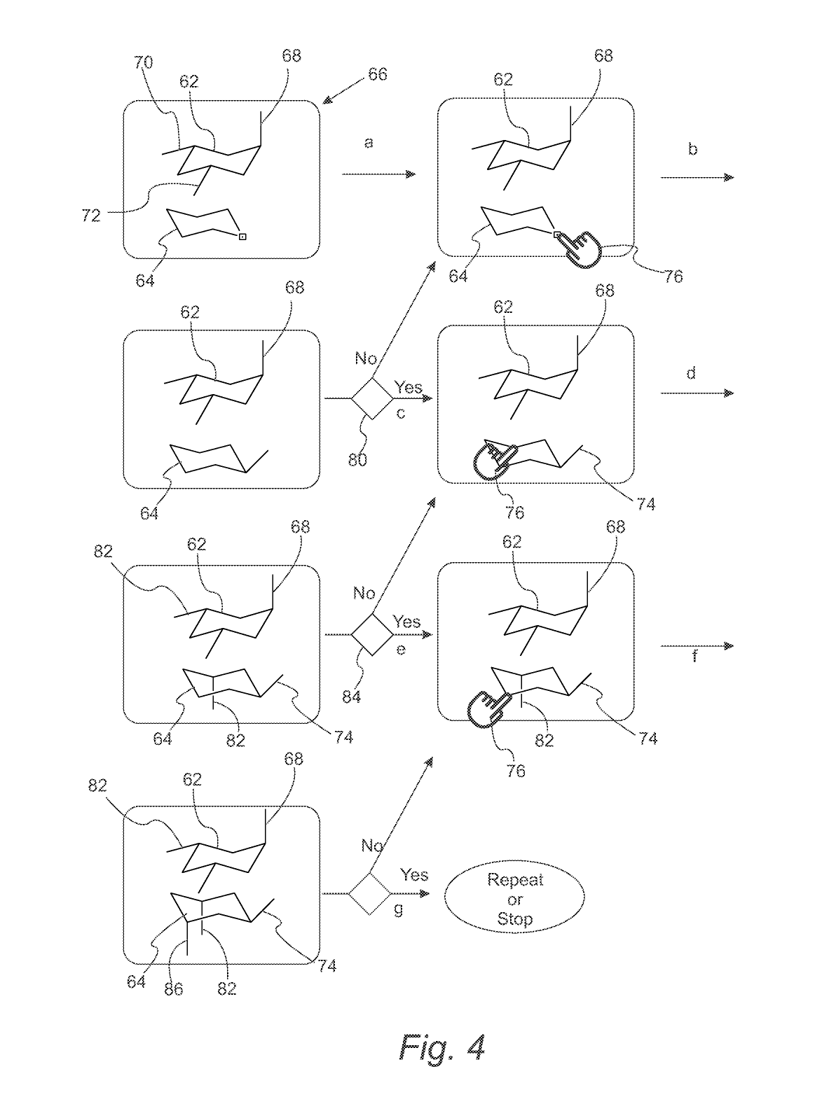

With reference to FIGS. 1 and 4, a variation of the cyclohexane stereochemistry game in which the positions of two axial or equatorial bonds are to be identified is provided. FIG. 4 is a schematic flowchart showing a game in which the positions of three axial or equatorial bonds are to be identified. In step a), a first drawing 62 of a cyclohexane ring in a first chair conformation and a second drawing 64 of a cyclohexane ring in a second chair conformation as depicted in screen image 66. The first drawing 62 of a cyclohexane ring displays bonds 68, 70, and 72 each independently in either an axial or equatorial position. Characteristically, the second chair conformation is different than the first chair conformation. The computer processor 12 is further configured to receive in step b) a first input 74 from the user 76 for a carbon position of the bond 68 and an angular orientation of the bond 68. The computer processor is also configured to indicate to the user whether the first input was correct or incorrect as indicated by decision point 80 of step c). In a variation, if user 76 has not drawn the bond correctly, computer processor 12 is further configured to loop back and provide the user with another chance. If the user has correctly drawn bond 68, the computer processor is further configured to execute step d) in which a second input 82 from the user 76 for a carbon position of the bond 70 and an angular orientation of the bond 70 is received. The computer processor is also configured to indicate to the user whether the second input 82 was correct or incorrect as indicated by decision point 84 of step e). In a variation, if user 76 has not drawn the bond correctly, computer processor 12 is further configured to loop back and provide the user with another chance. If the user has correctly drawn bond 70, the computer processor is further configured to execute step f) in which a third input 86 from the user 76 for a carbon position of the bond 72 and an angular orientation of the bond 70 is received. The computer processor is also configured to indicate to the user whether the third input 86 was correct or incorrect as indicated by decision point 84 of step g). If the user has correctly drawn bond 72, the computer processor is further configured to either end the game or provide another cyclohexane drawing.

In a variation, if user 32 has not drawn bond 50 correctly, computer processor 12 is further configured to loop back and provide the user with another chance. If the user has correctly drawn bond 48, the computer processor is further configured to either end the game or provide another cyclohexane drawing.

In a refinement of the embodiments and variations set forth above, the process is repeated with the user achieving a cumulative score indicated the user's success. Specifically, the processor is configured to present additional drawings of a cyclohexane ring after the user has provided input for a preceding drawing. In a refinement, the additional drawings can be presented in groups with the user providing an input for each drawing or the additional drawings presented sequentially.

In another embodiment, a non-transitory computer-readable medium that includes instructions for one or more of the cyclohexane stereochemistry games is provided. Details regarding non-transitory computer-readable media are set forth above. Specific examples of such non-transitory memory include but are not limited to read only memory (ROM), hard drives, optical drives, removable media (e.g. compact disks, DVD, flash drives, memory cards, etc.), and the like, and combinations thereof. The instructions, when executed by a computer processor, perform operations that present a user with a first drawing of a cyclohexane ring in a first chair conformation and that present to the user a second drawing of a cyclohexane ring in a second chair conformation. The first drawing of a cyclohexane ring displays a first bond in either an axial or equatorial position. The second chair conformation is characteristically different than the first chair conformation. The instructions when executed also perform operations that receive a first input from the user for a carbon position of the first bond and an angular orientation of the first bond and then indicate to the user that the first input was correct or incorrect. Additional details regarding the operations performed by the instructions are set forth above with respect to the electronic devices described by FIGS. 1-3. Moreover, non-transitory computer-readable medium is used in a desktop computer, a smart phone, a tablet, or a tablet computer.

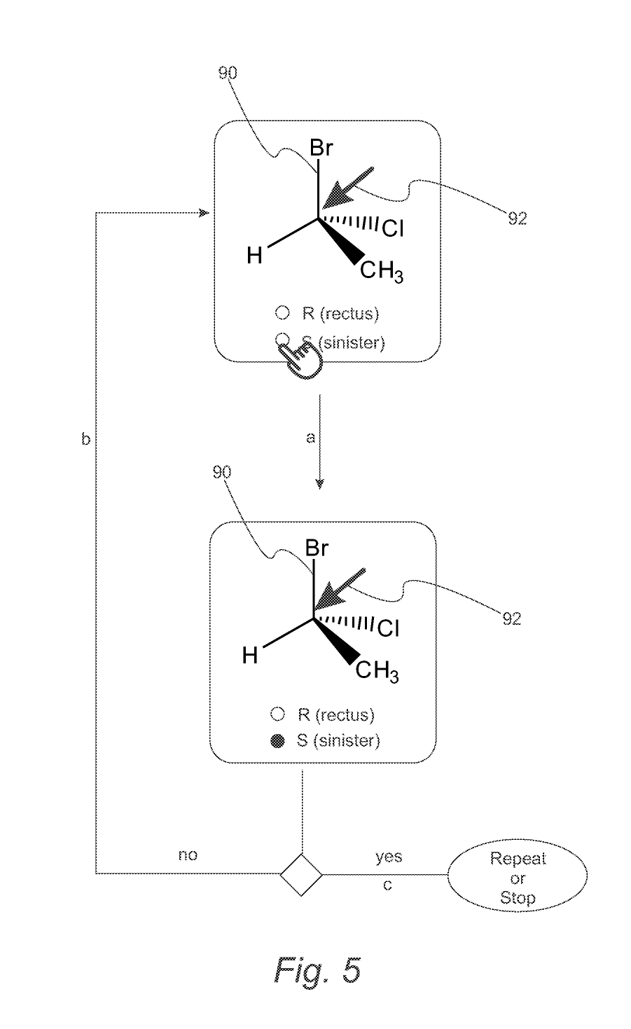

In another embodiment, a stereoisomer game in which a user identified chiral centers is provided. With reference to FIGS. 1 and 5, an electronic device to implementing this chiral center game is provided. FIG. 5 is a schematic flowchart illustrating an example of the game and operation of electronic device 10. In step a), computer processor 12 presents a molecular structure 90 to a user (e.g., player). An arrow 92 points at a chiral center. Computer processor 12 is further configured to receive an input from user 94 identifying the chiral center as an R, rectus, or S, sinister, absolute configuration. As indicated by decision point 96, computer processor 12 is configured to decide if the user's input was correct. If it is incorrect, the user is provided another opportunity to provide a correct answer as indicated by loop b). If the input is correct, the computer processor is further configured to either end the game or provide chemical structure for chiral center identification as indicated by step c). The first four levels of the game use the same molecule, 1-bromo-1-chloroethane but different projections of the molecule. Level one uses dash/wedge drawing, level two uses Newman projections, level three uses Fischer projections. In level four, other molecules with one chiral carbon are presented using the various projections. In level six, molecules with two chiral carbons are presented and the choices are R, S or achiral, for when the molecule is meso. All of the above levels can be played with either scoring using ten problems or with time-limited scoring as described in the Chair game. They also can be played unscored and this option allows for the player to view the molecule in three-dimensions using JSmol code. (JSmol is an open-source HTML5 viewer for chemical structures in 3D, wiki.jmol.org/index.php/JSmol#JSmol). Level 6 of the game is unscored and complex molecules are presented and the player must choose between chiral or achiral. These molecules can be viewed in three dimensions with JSmol and each molecule has a brief description of its structure and/or significance. In another embodiment, a non-transitory computer-readable medium that includes instructions for a chiral center game application is provided. The details for the non-transitory computer-readable medium are the same as those set forth above.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An electronic device for playing a game:
a display;
a computer processor configured to:
present to a user with a first drawing of a cyclohexane ring in a first chair conformation, the first drawing of a cyclohexane ring displaying a first bond in either an axial or equatorial position;
present to the user a second drawing of a cyclohexane ring in a second chair conformation, the second chair conformation being different than the first chair conformation;
receive a first input from the user for a carbon position of the first bond and an angular orientation of the first bond; and
indicate to the user that the first input was correct or incorrect.

2. The electronic device of claim 1 wherein the display is a touch screen display by which the user creates the first input using touch screen operations to draw the first input.

3. The electronic device of claim 1 further comprising a pointing device with which the user creates the first input.

4. The electronic device of claim 1 wherein the computer processor is further configured to identify the angular orientation as axial or equatorial.

5. The electronic device of claim 1 wherein the computer processor is further configured to receive a subsequent input from the user if the first input was incorrect.

6. The electronic device of claim 1 wherein the first drawing of a cyclohexane ring displays at least one additional bond in either an axial or equatorial position.

7. The electronic device of claim 6 wherein the computer processor is further configured to receive an additional input from the user for a carbon position of the additional bond and an angular orientation of the additional bond.

8. The electronic device of claim 1 wherein the computer processor is configured to present additional drawings of a cyclohexane ring after the user has provided input for a preceding drawing.

9. The electronic device of claim 8 wherein the additional drawings are sequentially presented.

10. The electronic device of claim 8 wherein the computer processor is configured to present a score of a user's successes.

11. The electronic device of claim 1 wherein the device is a desktop computer, a smart phone, a tablet, or a tablet computer.

12. A non-transitory computer-readable medium comprising instructions of a game application that, when executed by a computer processor, perform operations including to:
present to a user with a first drawing of a cyclohexane ring in a first chair conformation, the first drawing of a cyclohexane ring displaying a first bond in either an axial or equatorial position;
present to the user a second drawing of a cyclohexane ring in a second chair conformation, the second chair conformation being different than the first chair conformation;
receive a first input from the user for a carbon position of the first bond and an angular orientation of the first bond; and
indicate to the user that the first input was correct or incorrect.

13. The non-transitory computer-readable medium of claim 12 wherein the computer processor further performs operations to identify the angular orientation as axial or equatorial.

14. The non-transitory computer-readable medium of claim 12 wherein the computer processor further performs operations to receive a subsequent input from the user if the first input was incorrect.

15. The non-transitory computer-readable medium of claim 12 wherein the first drawing of a cyclohexane ring displays at least one additional bond in either an axial or equatorial position.

16. The non-transitory computer-readable medium of claim 15 wherein the computer processor further performs operations to receive an additional input from the user for a carbon position of the additional bond and an angular orientation of the additional bond.

17. The non-transitory computer-readable medium of claim 12 wherein the computer processor further performs operations to present additional drawings of a cyclohexane ring after the user has provided input for a preceding drawing.

18. The non-transitory computer-readable medium of claim 17 wherein the additional drawings are sequentially presented.

19. The non-transitory computer-readable medium of claim 17 wherein the computer processor further performs operations to present a score of a user's successes.

20. The non-transitory computer-readable medium of claim 12 wherein the computer processor is included in a desktop computer, a smart phone, a tablet, or a tablet computer.
